(19) United States
(12) Patent Application Publication
(10) Pub. No.: US 2016/0182605 A1
(43) Pub. Date: Jun. 23, 2016

(54) Dynamic Content Aggregation

(71) Applicant: Johnson Wong, Vancouver (CA)

(72) Inventor: Johnson Wong, Vancouver (CA)

(21) Appl. No.: 14/577,954

(22) Filed: Dec. 19, 2014

(51) Int. Cl. H04L 29/08; H04L 29/06

(52) U.S. Cl. CPC H04L 67/06; H04L 67/42; H04L 67/10

(57) ABSTRACT

Parts of an application are stored in a shared memory with each of the parts being associated with a unique identifier. For example, a JavaScript application may be stored as separate modules using asynchronous module definition (AMD). A server connected to the shared memory receives a request (e.g., via a representational state transfer (REST) API) from a client device for specified parts of the application. An aggregation component then identifies the specified parts in the memory based on their identifiers. The aggregation component then aggregates the specified parts and sends them to the requesting client device as one file. The client device then parses the one file to obtain the specified parts of the application and execute them. The application parts may be stored hierarchically by including multiple child parts in larger but less numerous parent parts so the number of parts to be aggregated can be controlled.

### TECHNICAL FIELD

This document generally relates to methods and systems for storing and providing application content in granular manner. More particularly, this document relates to dynamically aggregating separate application content at runtime.

### BACKGROUND

With the growth of mobile device use and applications that access content over networks there is an increasing need for efficiency in order to reduce the problem of network latency. When an application loads many files from a local device (e.g., on which it is executing), latency is generally negligible. However, over networks (e.g., the web) and especially over slower networks, latency can add up to greatly decrease the responsiveness of an application and ultimately negatively affect the user experience.

The performance of a website may be improved, for example, by bypassing a synchronous loading of any application content in favor of dynamically and asynchronously loading the content. However, dynamically loading a set of application content over a network incurs the increasing cost of network round-trips as the granularity of the application content becomes finer (e.g., more trips are required).

### BRIEF DESCRIPTION OF DRAWINGS

The present disclosure is illustrated by way of example and not limitation in the figures of the accompanying drawings, in which like references indicate similar elements and in which:

FIG. 1 is a block diagram illustrating a system for dynamically providing application content, in accordance with an example embodiment.

FIG. 2 is a ladder diagram illustrating a method, in accordance with an example embodiment, for aggregating application content at runtime.

FIG. 3 is a diagram illustrating a method, in accordance with an example embodiment, for managing the granularity of stored application content.

FIG. 4 is a ladder diagram illustrating a method, in accordance with an example embodiment, for aggregating application content at runtime using a cache.

FIG. 5 is a flow diagram illustrating a method, in accordance with an example embodiment, for aggregating application content at runtime.

FIG. 6 is a flow diagram illustrating a method, in accordance with an example embodiment, for aggregating application content at runtime using a cache.

FIG. 7 is a block diagram illustrating a mobile device, according to an example embodiment.

FIG. 8 is a block diagram of a machine in the example form of a computer system within which instructions for causing the machine to perform any one or more of the methodologies discussed herein can be executed.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter can be practiced without these specific details. In general, well-known instruction instances, protocols, structures, and techniques have not been shown in detail.

One method of handling network latency when running a networked application (e.g., web application) is to combine as much application content as possible into a single file at compile time, thereby leading to a single network round trip when the networked application is executed. Although this may solve the problem for small simple applications, larger more complex applications cannot simply be combined into a single file as the aggregate file will end up so large that the time to transfer the entire file as well as parse and execute it on the client-side may be greater than the time for loading smaller subsets of content as individual files only when they are needed, even if this results in incurring the network latency cost of multiple round-trips to the server.

Another issue with combining all of the application content at compile time is that this may lead to static application artifacts that are unable to change dynamically to adapt to contextual factors such as platform (ex. desktop vs mobile), user-rights (ex. guest vs admin) and feature enablement (ex. standard vs pro). Furthermore, if the number of combinations of possible application deployment scenarios becomes too large, it may be undesirable to have different static artifacts constructed for each application deployment scenario.

In an example embodiment, parts of an application are stored in a shared memory (e.g., a database) with each of the parts being associated with a unique identifier. A server connected to the shared memory receives a request from a client device for specified parts of the application. An aggregation component then identifies the specified parts in the shared memory based on their identifiers. The aggregation component then aggregates the specified parts and sends them to the client device as one file, for example, by concatenating the parts. The client device then parses the received file to obtain the specified parts of the application and execute them. The application parts may be stored hierarchically so that the number of parts to be aggregated can be controlled by including multiple child parts in larger but less numerous parent parts.

In an example embodiment, a server (or connected database) may utilize a cache to improve performance. The cache stores frequently-accessed data from the database and is generally faster to access than the underlying database. Furthermore, the cache may store the aggregated application content so that even the computational overhead of aggregating the content may be optimized. Generally, when a request is received, the cache is checked first to see if the requested data is in the cache (called a “cache hit”). If so, the requested data is retrieved from the cache. Only if the requested data is not in the cache (called a “cache miss”) is the underlying database accessed for the requested data. Any such data retrieved from the database may then be aggregated with any already aggregated data retrieved from the cache.

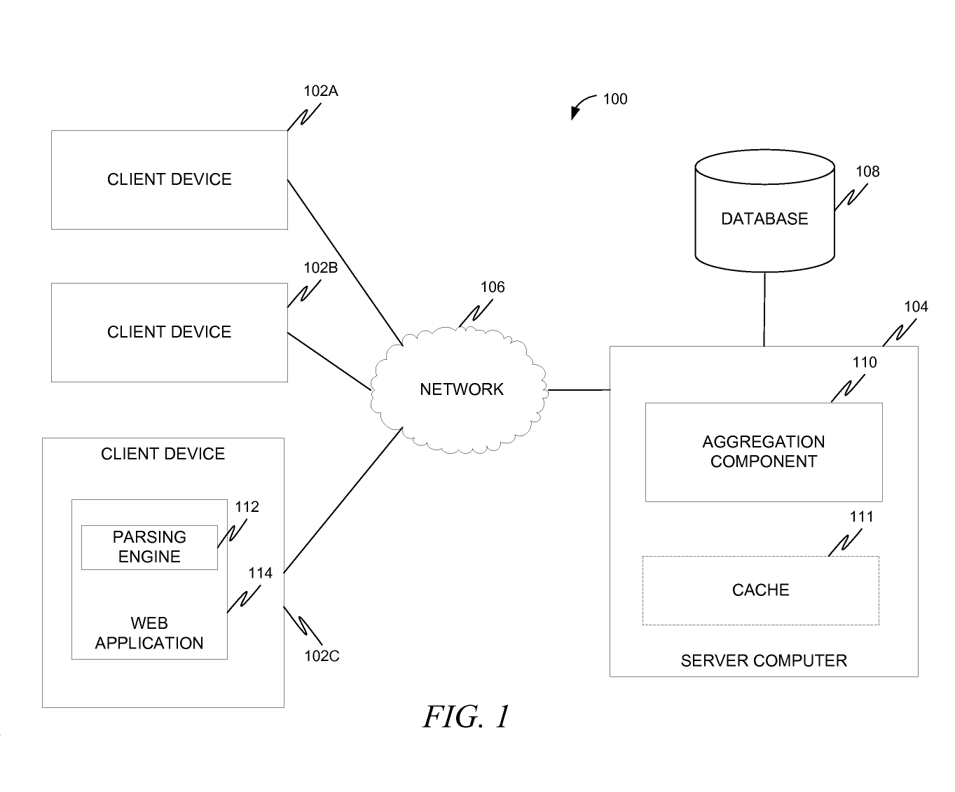

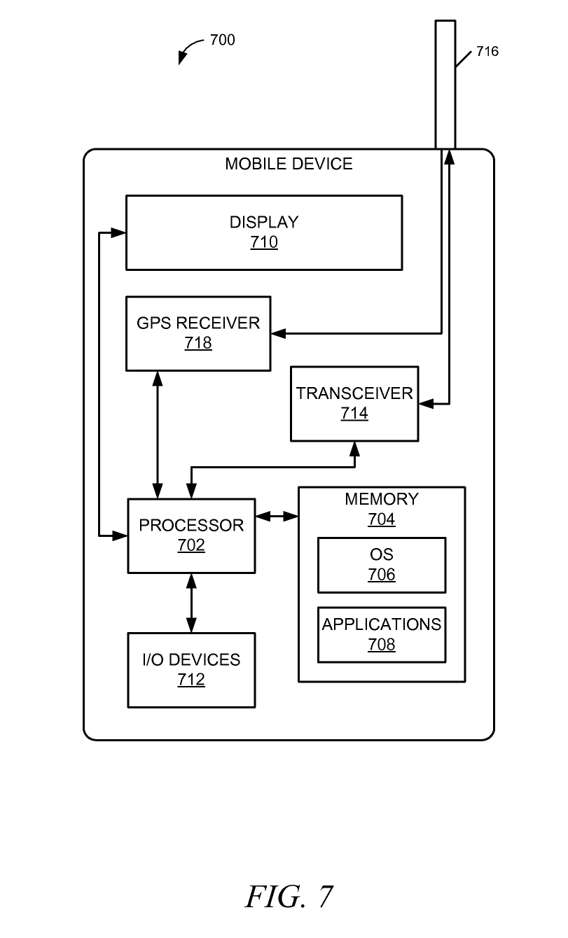

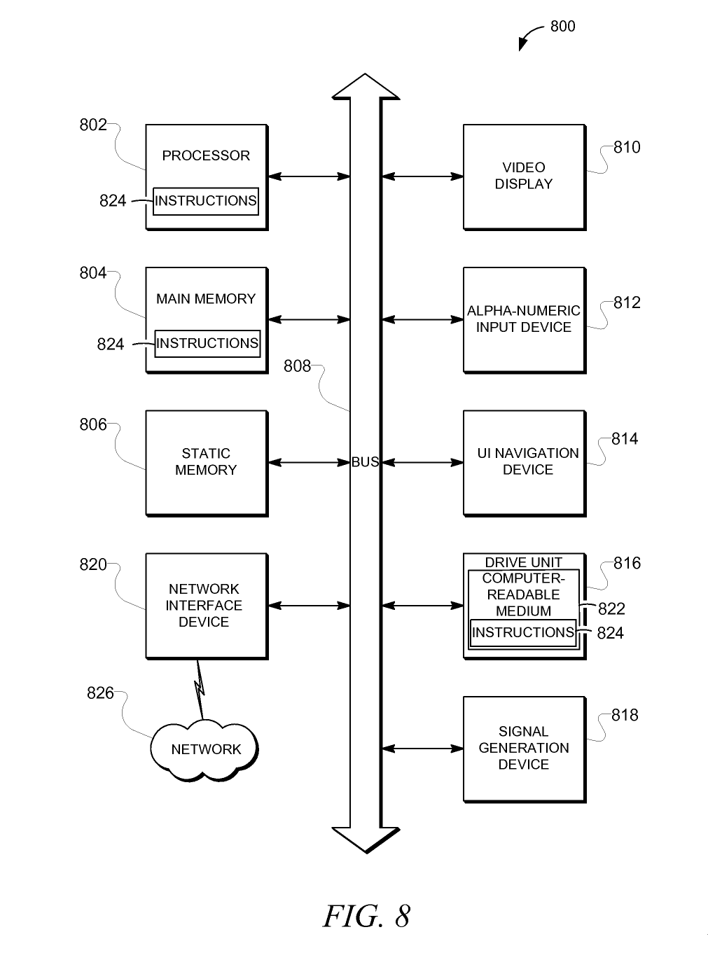

FIG. 1 is a block diagram illustrating a system for dynamically providing application content, in accordance with an example embodiment. The system includes a plurality of client devices 102A, 102B, and 102C, each connected to a server computer 104 via a network 106. The client devices 102A, 102B, and 102C may be, for example, mobile devices connected to server computer 104. The network 106 may be, for example, the Internet or any wired or wireless communications network, such as local area networks, wide area networks, etc. Example mobile devices will be described later with respect to FIG. 7. Example server computers will be described later with respect to FIG. 8. The server computer 104 can be connected to a database 108, which consolidates application data available to each of the mobile devices 102A, 102B, and 102C. The database 108 can be managed and/or accessed by an aggregation component 110 of server computer 104, which acts to identify and provide requested application content to the various mobile devices 102A, 102B, and 102C. The server computer 104 may optionally include a cache 111.

Mobile device 102C is depicted as including a web application 114 which can dynamically request application content from the server computer 104 connected to database 108. The web application 114 may include a parsing engine 112 for separating application parts that have been received as a single file from aggregation component 110. It should be noted that similar applications may also be present in mobile device 102A and mobile device 102B, but are simply not pictured in this diagram for brevity.

In an example embodiment, parts of the web application 114 (e.g., application content stored in a granular manner) are stored in database 108 (e.g., a shared memory) with each of the parts being associated with a unique identifier. The associated identifiers may be used to index the stored parts of web application 114 in the database 108 for the purpose of a quick “lookup” when any of the application parts is requested from server computer 104 by client device 102C. When the server computer 104 server receives a request from client device 102C for specified parts of web application 114, the aggregation component 110 identifies the specified parts in the database 108 based on the identifiers associated with each of the requested parts of the web application 114. The aggregation component 110 then aggregates the requested parts of web application 114 (e.g., by dynamically concatenating the requested parts) and sends the requested parts to the client device 102C as one file. The parsing engine 112 of web application 114 on client device 102C then parses the one file to obtain the requested specified parts of the web application 114. The web application 114 may then execute the requested application parts.

In an example embodiment, the parts of the web application 114 may be stored hierarchically in database 108 so that the number of parts of web application 114 to be aggregated by aggregation component 110 at runtime can be controlled. This may be necessary when the granularity of the stored parts of web application 114 is too fine, resulting in too much load on the back-end server computer 104 to fetch parts of the web application 114 from database 108 and dynamically aggregate them (e.g., if each request from the client results in the server fetching hundreds or thousands or more modules). A hierarchical storage the parts of the web application 114 may address this problem, for example, by storing the parts of the web application 114 (e.g., at compile time) as child parts wherein multiple child parts are included in less numerous parent parts that are of larger size. The aggregation component 110 may then aggregate only the parent parts that include any of the requested child parts at runtime thus lowering the computational load required to, for example, dynamically concatenate the requested parts.

In this way, if a higher granularity is desired (e.g., by client device 102C) so that only the specific parts of web application 114 that are needed are requested and received from server computer 104, then the parts of web application 114 may be stored in database 108 without any hierarchy. On the other hand, if lower granularity is desired (e.g., by server computer 104) in order to dynamically aggregate many parts of web application 114 from database 108 without as much processing expense, then the parts of web application 114 may be stored in database 108 with a hierarchy including larger parent nodes. This ability to vary the granularity of the application content (e.g., for web application 114) stored in database 108 to suit the specific application allows an application developer (e.g., at compile time) to strike a balance between the granularity of fetched application content and back-end server performance.

In an example embodiment, the server computer 104 (or the database 108) may utilize a cache 111 to improve performance in regard to retrieving requested application content (e.g., stored parts of web application 114). The cache 111 may store frequently-accessed parts of web application 114 from database 108 and is generally faster to access than the underlying database 108. Furthermore, the cache 111 may store the aggregated application content so that even the computational overhead of aggregating the application content may be optimized. Generally, when a request for a part of web application 114 is received from client device 102C, the server computer 104 (e.g., via aggregation component 110) may first check cache 111 to see if the requested part of the web application 114 is in the cache 111 (called a “cache hit”). If so, the requested parts of web application 114 are retrieved from the cache 111.

On the other hand, if the requested parts of the web application 114 are not identified by the server computer 104 in the cache 111 (called a “cache miss”), then the underlying database 108 is accessed by server computer 104 (e.g., via aggregation component 110) for the requested parts of the web application 114. Any such data retrieved from the database may then be aggregated with any already aggregated data retrieved from the cache 111. Additionally the server computer 104 (e.g., via aggregation component 110) may then store copies of the parts of the web application 114 retrieved from database 108 (e.g., in aggregated form) in cache 111 for facilitating any future retrieval of said parts based on the availability of memory in the cache 111.

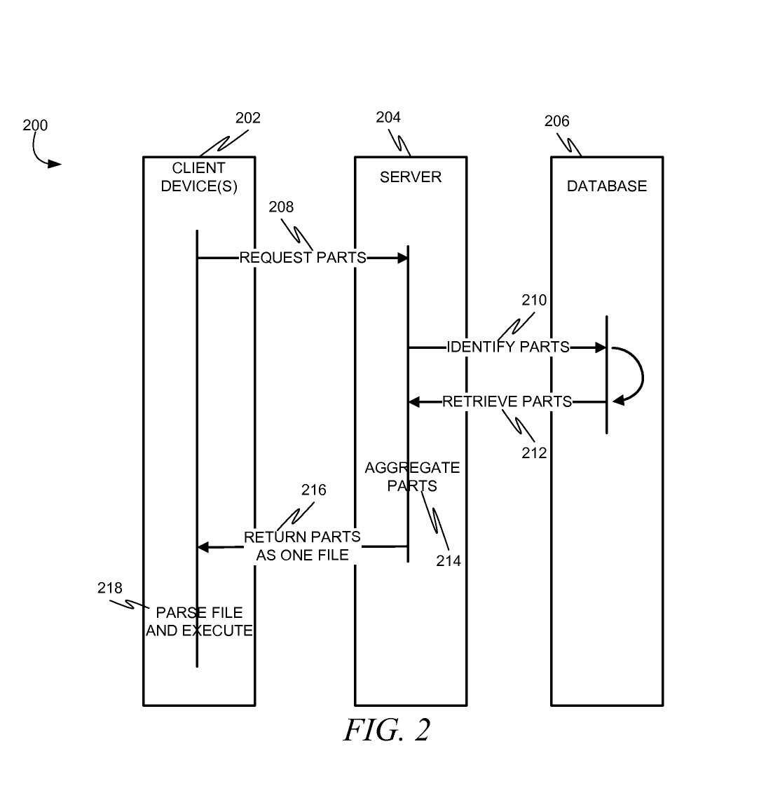

FIG. 2 is a ladder diagram illustrating a method 200, in accordance with an example embodiment, for aggregating application content at runtime. This method can utilize client device(s) 202 (e.g., client devices 102A, 102B, and 102C in FIG. 1), a server 204 (e.g., server computer 104 in FIG. 1), and a database 206 (e.g., database 108 in FIG. 1). For example, at operation 208 specified parts of an application (e.g., web application 114) that are stored in a granular manner in database 206, using unique identifiers associated with each of the parts, are requested from sever 204 by client 202. The application content (e.g., JavaScript) stored at database 206 may be separated into distinct parts which can be identified in some manner by following the “asynchronous module definition” (AMD) pattern to break an application down into modules (e.g., application parts), and have each uniquely identifiable by a module ID (e.g., unique identifiers). AMD is a JavaScript API for defining modules such that the module (and any dependencies) may be asynchronously loaded, e.g., the modules do not have to be loaded in any particular order. AMD may therefore be helpful in improving the performance of websites (e.g., on a browser application) by bypassing the synchronous loading of unneeded modules along with any unneeded website content.

The client device(s) 202 may request that a set of application content (e.g., parts or modules) be provided dynamically from the back-end by server 204 by using, for example, a “representational state transfer” (REST) API. REST is an abstraction of the structure of the World Wide Web including a coordinated set of rules applied to components, connectors, and data elements, within a distributed system (e.g., a network). The REST API does not focus on the details of distributed components and instead focuses on the roles of components, the interaction between components, and the interaction of components with significant data elements.

At operation 210 the server 204 identifies the requested specified parts in the database 108 based on the identifiers (e.g., based on an index created using AMD module IDs) associated with each of the specified parts of the application. The server 204 then, at operation 212, retrieves the requested parts of the application. The server 204 then, at operation 214, aggregates the requested parts of the application, for example, by dynamically concatenating the requested parts. The dynamic concatenation may be performed using standard string concatenation when dealing with JavaScript files, however this mechanism for dynamically aggregating application content is not limited to any particular type of application content.

Although the most typical application content type is text (ex. code, such as JavaScript) any content type can be aggregated. For example, images and other small media may be converted to a string format via data “uniform resource identifier” (URI) conversion. The data URI scheme provides a way to embed data items in web pages as “immediate” data, as if they were referenced externally. This technique allows normally separate elements such as images and style sheets to be fetched in a single HTTP request rather than multiple HTTP requests, which can be more efficient. Additionally, more complex file types can simply be represented as a stream of bytes in order to perform the aggregation. An application developer may then simply ensure that the server 204 and client device(s) 202 have compatible code for aggregating application content (e.g., by server 204) and subsequently reading it back out (e.g., by client device(s) 202) while being able to detect content boundaries (e.g., tell when one application part (e.g., module) ends and another part begins).

The server 204 may then, at operation 216, send the requested parts to the client device(s) 202 as one file of aggregated application parts. The client device(s) 202, at operation 218, may then parse the received one file to obtain the requested specified parts of the web application 114 and execute the specified parts. In reference to the above-example of using the AMD framework to breakdown application content into modules, concatenated AMD modules may be executed together despite still be registered into the client-side AMD framework of client device(s) 202 as distinct AMD modules. However, there may be circumstances where the execution of the AMD modules is not so simple. One example involves loading AMD modules that are associated with a specific AMD context, e.g., a minimal set of data used by a module that must be saved to allow a module execution interruption at a given date, and a continuation of the module execution at the point of interruption at an arbitrary future date. Therefore, to the extent that concatenated AMD modules may require different AMD contexts for loading, context switching code may be inserted between each concatenated module in order to ensure that each concatenated module is loaded into the required AMD contexts (e.g., see example below). In the present example of FIG. 2, the application back-end server 204 would insert such context switching code between modules as it dynamically concatenates them into a single file so that the client device(s) 202 may load the concatenated modules in the proper AMD context.

### Example Code for Switching Between AMD Contexts

startContext(“A”); // Code to context switch into context A
define(“moduleA”, ...); // Define some modules to be loaded into
context A
define(“moduleB”, ...);
...
endContext(“A”); // Code to context switch out of context A
startContext(“B”); // Code to context switch into context B
define(“moduleC”, ...); // Define some modules to be loaded into
context B
define(“moduleD”, ...);
...
endContext(“B”); // Code to context switch out of context B.

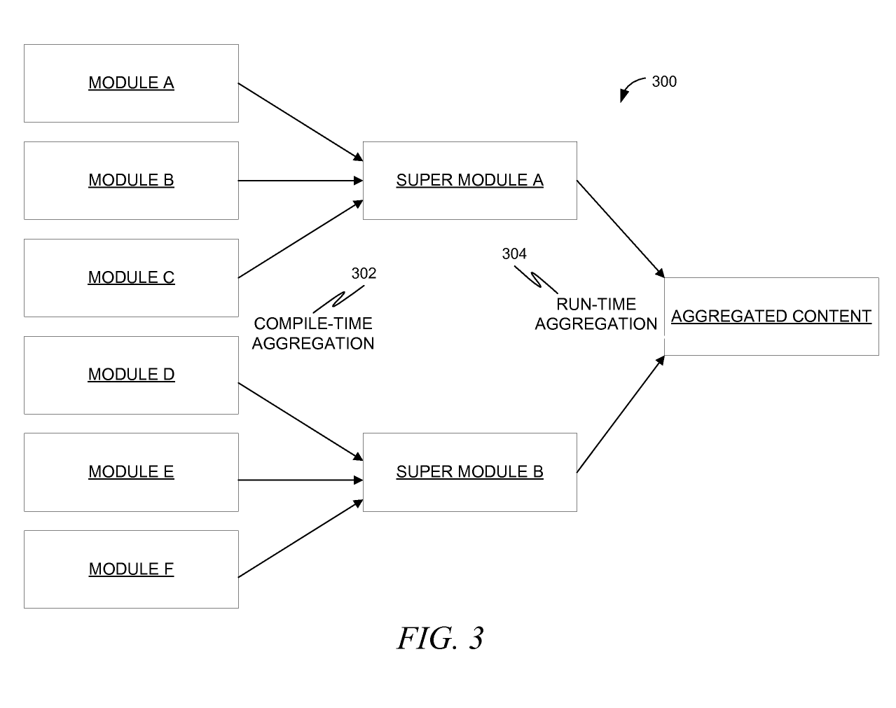

FIG. 3 is a diagram illustrating a method, in accordance with an example embodiment, for managing the granularity of stored application content. With reference to the elements illustrated in FIG. 1 and the AMD framework described above, FIG. 3 shows how the AMD modules (modules A-F) of web application 114 may be stored hierarchically in database 108 so that the number of modules of web application 114 to be aggregated by aggregation component 110 at runtime can be controlled. This may be necessary when the stored modules of web application 114 are too numerous, resulting in too much load on server computer 104 when fetching the modules of web application 114 from database 108 and dynamically aggregating them. For example, if each request from client device 102C results in the server computer 104 fetching hundreds or thousands of modules. Storing the modules (A-F) of web application 114 in a hierarchy may be used to address this problem, for example, by storing the modules (A-F) of web application 114 (e.g., at compile time 302) as child modules of larger “super modules” A and B that are less numerous. In the present example, modules A-C are children of super module A and modules D-F are children of super module B. The aggregation component 110 may then aggregate only the parent super modules A and B that include any of the child modules that are requested by client device 102C at runtime (e.g., run-time content aggregation 304) thus lowering the computational load for server computer 104 of, for example, dynamically concatenating requested modules. For example, if all shown modules A-F of web application 114 are requested by client device 102C at runtime, the server computer 104 would only have to identify and concatenate super modules A and B (e.g., run-time content aggregation 304) since they include all of the requested modules of web application 114.

The granularity of the application content for web application 114 that may be dynamically loaded is therefore arbitrary since the described mechanism scales to any level of granularity by applying a hierarchy to the content of web application 114. As shown in the example of FIG. 3, web application 114 could be broken down into super modules A and B where each super-module consists of multiple modules (A-C and D-F respectively). In this example, the web application 114 is hierarchically stores as super modules A and B as part of compiling/building the application code for web application 114.

In this way, if a higher granularity is desired (e.g., by client device 102C) so that only the specific modules of web application 114 that are needed are requested and received from server computer 104, then the modules A-F of web application 114 may be stored in database 108 without any hierarchy imposed on the modules. On the other hand, if lower granularity is desired (e.g., by server computer 104) in order to dynamically aggregate many modules of web application 114 from database 108 without as much processing expense, then the modules of web application 114 may be stored in database 108 with a hierarchy including larger super modules A and B. This ability to vary the granularity of the content of web application 114 stored in database 108 to suit the specific needs of the system (e.g., server computer 104, client device 102C and web application 114) allows an application developer (e.g., at compile time 302) to strike a balance between the granularity of fetched application content (e.g., modules A-F) and the back-end performance of server computer 104.

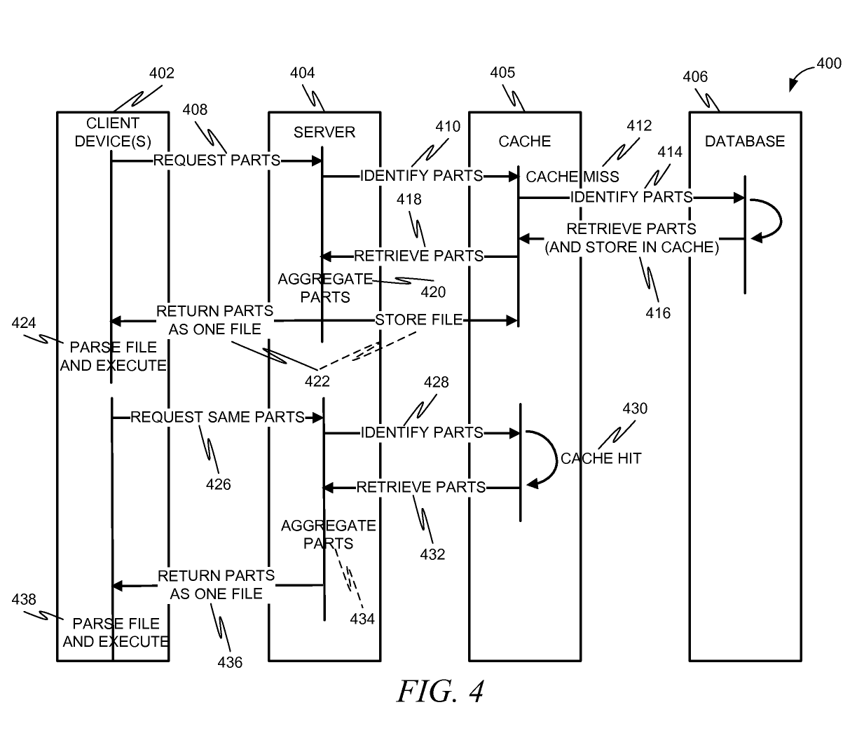

FIG. 4 is a ladder diagram illustrating a method 400, in accordance with an example embodiment, for aggregating application content at runtime using a cache. This method can utilize client device(s) 402 (e.g., client devices 102A, 102B, and 102C in FIG. 1), a server 404 (e.g., server computer 104 in FIG. 1), a cache 405 (e.g., cache 111 in FIG. 1) and a database 406 (e.g., database 108 in FIG. 1). The use of a cache may result in one extra lookup by server 404 on each request from client device(s) 402 because cache 405 needs to be checked for application parts before attempting to perform the more expensive dynamic content fetching from database 406. Furthermore, the use of a cache includes the need for additional logic (in server 404 or database 406) to create and manage cache 405. However, the cache 405 is generally faster to access than the underlying database 406. Furthermore, the cache 405 may store the aggregated application content files so that even the computational overhead for server 404 of aggregating application content may be optimized.

At operation 408 specified parts of an application (e.g., web application 114) that are stored in a granular manner in database 406, using unique identifiers associated with each of the parts, are requested from sever 404 by a client 402. At operation 410 the server 404 attempts to identify the requested application parts in the files stored in cache 405 and fails (“cache miss” 412). At operation 414 the server proceeds to identify the requested application parts in the underlying database 406. Additionally, at operation 416, the server 404 may then retrieve the requested application parts from database 406 and may optionally store copies of said requested parts in cache 405 for any future retrieval of said parts if memory is available in the cache 405.

The server 404 then, at operation 420, aggregates the requested parts of the application, for example, by dynamically concatenating the requested parts. The server 404 may then, at operation 422, send the requested parts to the client device(s) 402 as one file by aggregating the application parts and may optionally store a copy of the file in cache 405 for facilitating any future retrieval and aggregation of said parts if memory is available in the cache 405. The client device(s) 402, at operation 424, may then parse the one file to obtain the requested application parts and execute the specified parts.

At operation 426, a client device 402 may request the same application parts as were previously requested at operation from sever 404. At operation 428, the server 404 attempts to identify the requested application parts in the cache 405 (e.g., in the files stored in cache 405) and succeeds (“cache hit” 430). At operation 432 the server proceeds to retrieve the requested application parts from the cache 405 or, if available, the already aggregated requested application parts from at least one file stored in cache 405. The server 404 may then, at optional operation 434, aggregate the requested parts of the application, for example, by dynamically concatenating any application parts retrieved from the cache 405 and any already aggregated application parts retrieved from separate files in cache 405. If all of the requested application parts are already aggregated into a single file stored in the cache 405, then aggregation step 434 may be bypassed since a single file containing all of the requested application parts is already available. The server 404 may then, at operation 436, send the requested parts to the client device(s) 402 as one file of aggregated application parts, e.g., the single aggregated file containing all requested application parts. The client device(s) 402, at operation 438, may then parse the aggregated parts of the received one file to obtain the requested application parts and then proceed to execute the specified parts.

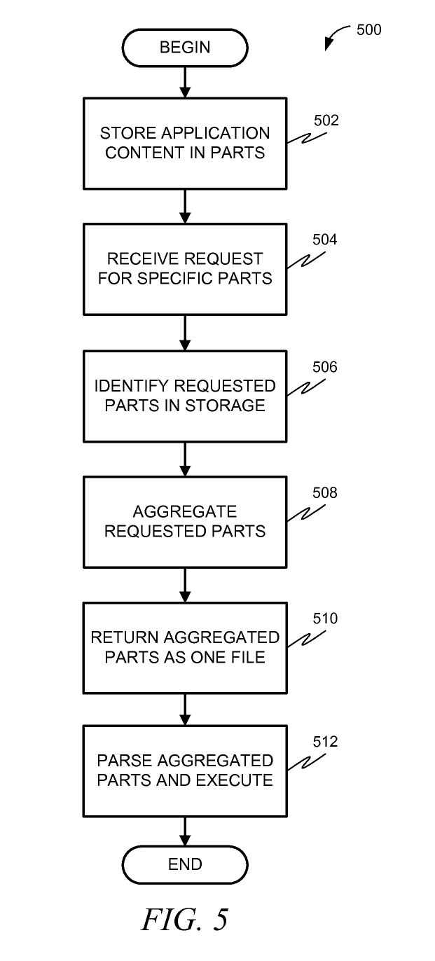

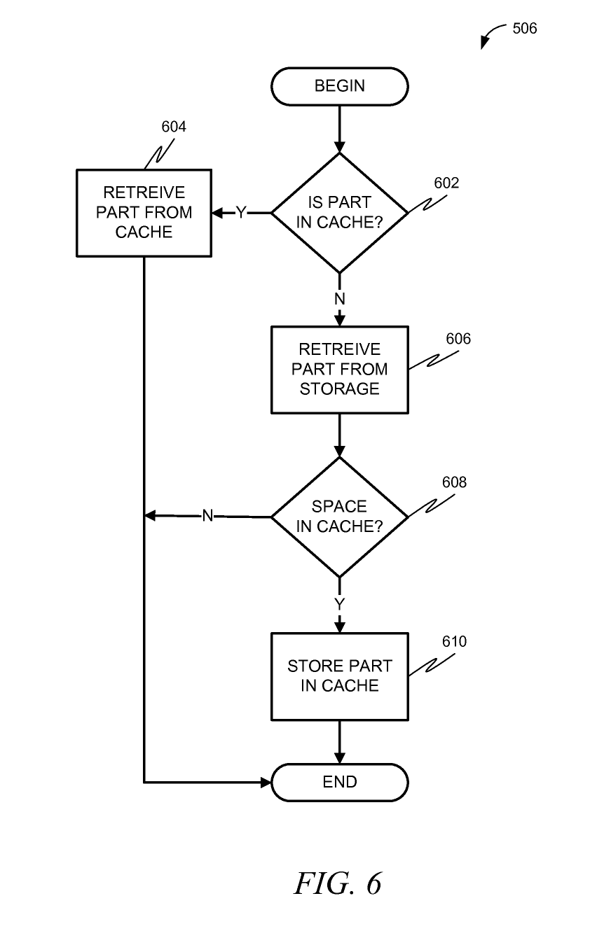

FIG. 5 is a flow diagram illustrating a method, in accordance with an example embodiment, for aggregating application content at runtime. Method 500 can be performed by processing logic that can comprise hardware (e.g., circuitry, dedicated logic, programmable logic, microcode, etc.), software (e.g., instructions run on a processing device), or a combination thereof. In one implementation, at least one or more portions of method 500 are performed by a cache 111 of FIG. 1, as described above with respect to FIG. 3 and below with respect to FIG. 6.

At operation 502, an application is stored in an electronic storage (e.g., database) in a granular fashion as separate application parts, for example, with each of the parts being associated with a unique identifier. At operation 504, a server receives a request from a client device for specific parts of the stored application. At operation 506, the server identifies the requested specific parts in the storage, for example, based on the identifiers associated with each of the requested parts of the application. At operation 508, the server aggregates the identified requested parts of the application, for example, by dynamically concatenating the requested parts. At operation 510, the server sends the requested parts to the client device as one file including the aggregated (e.g., concatenated) application parts. At operation 512, the client device parses the received aggregated/concatenated parts from the one file to obtain the requested parts of the application and execute the requested application parts.

FIG. 6 is a flow diagram illustrating a method 600, in accordance with an example embodiment, for aggregating application content at runtime using a cache. This flow diagram can illustrate, for example, operation 506 of FIG. 5 in more detail. Method 600 can be performed by processing logic that can comprise hardware (e.g., circuitry, dedicated logic, programmable logic, microcode, etc.), software (e.g., instructions run on a processing device), or a combination thereof.

At operation 602, it is determined if a requested application part is in a cache (of the server or the electronic storage), or if a hierarchical storage of application parts is being used then it may be determined if a parent part that includes any of the requested application parts is in the cache. The application parts stored in the cache may be stored as files including aggregated application parts. At operation 604, if the requested application part (or a parent thereof) is identified in the cache (e.g., in a file stored in the cache) then said requested application part (or parent thereof) is retrieved from the cache and the method 600 proceeds to the end. At operation 606, if the requested application part (or a parent thereof) is not identified in the cache then said requested application part (or parent thereof) is retrieved from the electronic storage. At operation 608, it is determined if there is free memory (e.g., space) available in the cache and if not the method 600 proceeds to the end. At operation 610, if it is determined that there is space in the cache then a copy of the retrieved application part (or a parent thereof) is stored in the cache. As noted above, the application parts may be stored in the cache as one file after they have been aggregated.

### Example Mobile Device

FIG. 7 is a block diagram illustrating a mobile device 700, according to an example embodiment. The mobile device 700 can include a processor 702. The processor 702 can be any of a variety of different types of commercially available processors suitable for mobile devices (for example, an XScale architecture microprocessor, a Microprocessor without Interlocked Pipeline Stages (MIPS) architecture processor, or another type of processor). A memory 704, such as a Random Access Memory (RAM), a Flash memory, or another type of memory, can be accessible to the processor. The memory 704 can be adapted to store an operating system (OS) 706, as well as application programs 708, such as a mobile location enabled application that can provide LBSs to a user. The processor 702 can be coupled, either directly or via appropriate intermediary hardware, to a display 710 and to one or more input/output (I/O) devices 712, such as a keypad, a touch panel sensor, a microphone, and the like. Similarly, in some embodiments, the processor 702 can be coupled to a transceiver 714 that interfaces with an antenna 716. The transceiver 714 can be configured to both transmit and receive cellular network signals, wireless data signals, or other types of signals via the antenna 716, depending on the nature of the mobile device 700. Further, in some configurations, a GPS receiver 718 can also make use of the antenna 716 to receive GPS signals.

### Modules, Components and Logic

Certain embodiments are described herein as including logic or a number of components, modules, or mechanisms. Modules can constitute either software modules (e.g., code embodied (1) on a non-transitory machine-readable medium or (2) in a transmission signal) or hardware-implemented modules. A hardware-implemented module is a tangible unit capable of performing certain operations and can be configured or arranged in a certain manner. In example embodiments, one or more computer systems (e.g., a standalone, client or server computer system) or one or more processors can be configured by software (e.g., an application or application portion) as a hardware-implemented module that operates to perform certain operations as described herein.

In various embodiments, a hardware-implemented module can be implemented mechanically or electronically. For example, a hardware-implemented module can comprise dedicated circuitry or logic that is permanently configured (e.g., as a special-purpose processor, such as a field programmable gate array (FPGA) or an application-specific integrated circuit (ASIC)) to perform certain operations. A hardware-implemented module can also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) can be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor can be configured as respective different hardware-implemented modules at different times. Software can accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules can be regarded as being communicatively coupled. Where multiple such hardware-implemented modules exist contemporaneously, communications can be achieved through signal transmission (e.g., over appropriate circuits and buses) that connect the hardware-implemented modules. In embodiments in which multiple hardware-implemented modules are configured or instantiated at different times, communications between such hardware-implemented modules can be achieved, for example, through the storage and retrieval of information in memory structures to which the multiple hardware-implemented modules have access. For example, one hardware-implemented module can perform an operation and store the output of that operation in a memory device to which it is communicatively coupled. A further hardware-implemented module can then, at a later time, access the memory device to retrieve and process the stored output. Hardware-implemented modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions. The modules referred to herein may, in some example embodiments, comprise processor-implemented modules.

Similarly, the methods described herein can be at least partially processor-implemented. For example, at least some of the operations of a method can be performed by one of processors or processor-implemented modules. The performance of certain of the operations can be distributed among the one or more processors, not only residing within a single machine, but deployed across a number of machines. In some example embodiments, the processor or processors can be located in a single location (e.g., within a home environment, an office environment or a server farm), while in other example embodiments the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments can be implemented in digital electronic circuitry, or in computer hardware, firmware, software, or combinations of these. Example embodiments can be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors executing a computer program to perform functions by operating on input data and generating output. Method operations can also be performed by, and apparatus of example embodiments can be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware can be a design choice. Below are set out hardware (e.g., machine) and software architectures that can be deployed, in various example embodiments.

### Machine Architecture and Machine-Readable Medium

FIG. 8 is a block diagram of a machine in the example form of a computer system 800 within which instructions for causing the machine to perform any one or more of the methodologies discussed herein can be executed. In alternative embodiments, the machine can operate as a standalone device or can be connected (e.g., networked) to other machines. In a networked deployment, the machine can operate in the capacity of a server or a client machine in server-client network environment, or as a peer machine in a peer-to-peer (or distributed) network environment. The machine can be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804 and a static memory 806, which communicate with each other via a bus 808. The computer system 800 can further include a video display unit 810 (e.g., a liquid crystal display (LCD) or a cathode ray tube (CRT)). The computer system 800 can also include an alpha-numeric input device 812 (e.g., a keyboard or a touch-sensitive display screen), a user interface (UI) navigation device 814 (e.g., a mouse), a drive unit 816, a signal generation device 818 (e.g., a speaker), and a network interface device 820.

### Machine-Readable Medium

The disk drive unit 816 includes a computer-readable medium 822 on which is stored one or more sets of instructions and data structures (e.g., software) 824 embodying or utilized by any one or more of the methodologies or functions described herein. The instructions 824 can also reside, completely or at least partially, within the main memory 804 and/or within the processor 802 during execution thereof by the computer system 800, the main memory 804 and the processor 802 also constituting machine-readable media.

While the machine-readable medium 822 is shown in an example embodiment to be a single medium, the term “machine-readable medium” can include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 824 can further be transmitted or received over a communications network 826 using a transmission medium. The instructions 824 can be transmitted using the network interface device 820 and any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes can be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method comprising:
storing parts of an application in a shared memory, each of the parts associated with a unique identifier;
receiving a request at a server, from a client device, for specified parts of the application;
identifying the specified parts in the shared memory based on their associated identifiers;
aggregating the specified parts and sending them as one file to the client device.

2. The method of claim 1, further comprising:
parsing the one file by the client device; and
executing the specified parts of the application.

3. The method of claim 1, wherein sending the aggregated parts as one file includes concatenating the aggregated parts.

4. The method of claim 3, wherein the application includes JavaScript and the parts comprise modules defined using asynchronous module definition (AMD) such that each module can be asynchronously loaded, and the associated unique identifiers comprise AMD module IDs.

5. The method of claim 4, wherein aggregating the specified parts comprises aggregating specified modules, and concatenating the aggregated parts comprises concatenating aggregated modules and adding code before at least one concatenated module so that the at least one concatenated module is associated with a specific AMD context.

6. The method of claim 2, wherein the client device requests specified parts of the application via a representational state transfer (REST) API.

7. The method of claim 1, wherein the parts are stored hierarchically as child parts included in associated parent parts, the method further comprising:
in response to the request for specified parts of the application, identifying parent parts in the shared memory based on at least one of the specified application parts being a child of the parent part; and
aggregating the identified parent parts and sending them as one file to the client device.

8. The method of claim 1, wherein the server includes a cache for storing sent files including aggregated application parts, the method further comprising:
in response to the request for specified parts of the application, identifying a file in the cache including an aggregation of at least some of the specified parts based on their associated identifiers; and
based on identifying an aggregation of specified parts in the file, retrieving the aggregation of specified parts from the file for aggregation.

9. The method of claim 8, further comprising retrieving a specified part from the shared memory for aggregation based on a failure to identify a file in the cache including an aggregation of the specified part.

10. The method of claim 9, further comprising storing the sent files in the cache based on the availability of memory in the cache.

11. A system comprising:
a server connected to a database; and
at least one client device;
an aggregation component executable by a processor and configured to:
store parts of an application in the database, each of the parts associated with a unique identifier;
receive a request, from one of the at least one client devices, for specified parts of the application;
identify the specified parts in the database based on their associated identifiers;
aggregate the specified parts and sending them as one file to the requesting client device.

12. The system of claim 11, wherein the at least one client device is a mobile computing device configured to:
parse the one file; and
execute the specified parts of the application.

13. The system of claim 11, wherein the aggregation component is further configured to:
store the parts in the database hierarchically as child parts included in associated parent parts;
in response to the request for specified parts of the application, identify parent parts in the database based on at least one of the specified application parts being a child of the parent part; and
aggregate the identified parent parts and send them as one file to the requesting client device.

14. The system of claim 11, wherein the server includes a cache for storing sent files including aggregated application parts and the aggregation component is further configured to:
in response to the request for specified parts of the application, identify a file in the cache including an aggregation of at least some of the specified parts based on their associated identifiers; and
based on identifying an aggregation of specified parts in the file, retrieve the aggregation of specified parts from the file for aggregation.

15. The system of claim 14, wherein the aggregation component is further configured to retrieve a specified part from the database for aggregation based on a failure to identify a file in the cache including an aggregation of the specified part.

16. The system of claim 15, wherein the aggregation component is further configured to store the sent files in the cache based on the amount of memory available in the cache.

17. A non-transitory machine-readable storage medium comprising instructions, which when implemented by machines, cause the machines to perform operations comprising:
storing parts of an application in a shared memory, each of the parts associated with a unique identifier;
receiving a request, from one of the machines, for specified parts of the application;
identifying the specified parts in the shared memory based on their associated identifiers;
aggregating the specified parts and sending them as one file to the requesting machine.

18. The non-transitory machine-readable storage medium of claim 17, wherein the operations further comprise:
parsing the one file; and
executing the specified parts of the application.

19. The non-transitory machine-readable storage medium of claim 17, wherein the operations further comprise:
storing the parts hierarchically as child parts included in associated parent parts;
in response to the request for specified parts of the application, identifying parent parts in the shared memory based on at least one of the specified application parts being a child of the parent part; and
aggregating the identified parent parts and sending them as one file to the requesting machine.

20. The non-transitory machine-readable storage medium of claim 17, wherein the operations further comprise:
in response to the request for specified parts of the application, identifying a file in the cache including an aggregation of at least some of the specified parts based on their associated identifiers; and
based on identifying an aggregation of specified parts in the file, retrieving the aggregation of specified parts from the file for aggregation; and
based on a failure to identify a file in the cache including an aggregation of the specified part, retrieving a specified part from the shared memory for aggregation.
